(19) United States
(12) Patent Application Publication
(10) Pub. No.: US 2025/0272566 A1
(43) Pub. Date: Aug. 28, 2025

(54) AUTOMATED MULTIVARIATE SYSTEM PERFORMANCE ANALYSIS

(71) Applicant: Hexion Inc., Columbus, OH (US)

(72) Inventors: Daniel Phillip FORTUNE, Stafford, TX (US); Reza TASOOJI, Columbus, OH (US); Michael LEFENFELD, Columbus, OH (US); Mark D. AUCOIN, Dibll, TX (US)

(21) Appl. No.: 18/589,191

(22) Filed: Feb. 27, 2024

(51) Int. Cl. G06N 3/09

(52) U.S. Cl. CPC G06N 3/09

(57) ABSTRACT

The embodiments described herein generally relate to automated performance analysis of a system. Embodiments include receiving parameter values for a plurality of parameters captured during a time period. Embodiments include providing inputs based on the data set to a supervised machine learning model configured to determine significant parameters with respect to a target variable. Embodiments include receiving, from the supervised machine learning model in response to the inputs, an indication of two or more significant parameters from the plurality of parameters with respect to the target variable. Embodiments include generating a multivariate cluster for the target variable based on the two or more significant parameters and determining an anomalous state of the system with respect to the target variable based on the multivariate cluster for the target variable and data captured after the time period.

### FIELD

Embodiments of the present disclosure generally relate to automated system performance analysis. Embodiments of the present disclosure also generally relate to techniques for dynamic multivariate analysis of states of a system with respect to particular target variables for improved performance monitoring and alerts.

### BACKGROUND

Large amounts of data are collected in systems at various stages of processing, such as by sensors associated with various components. For example, manufacturing systems often involve the operation of many devices, and sensors associated with these devices may capture values related to device operations as processes are performed. This data may be aggregated and analyzed at computing devices, such as in order to identify anomalous or problematic values that may require remedial action.

Existing techniques for automatically analyzing data captured by sensors associated with systems generally involve comparing values to thresholds or otherwise looking for data trends that indicate problematic conditions. While these conventional techniques can provide some beneficial results, such techniques are limited in utility and fail to recognize more complex or nuanced conditions that should be addressed in order to improve performance. Furthermore, due to the large amounts of data generally captured in association with operation of systems, existing techniques may be inefficient, may expend computing resources analyzing data that is irrelevant, insignificant, or misleading, and may be unable to automatically recognize useful indicators among such large amounts of data.

Some existing techniques for analysis of system data rely on machine learning models that are trained to classify anomalous data, use particular clustering techniques such as k nearest neighbors (KNN), involve z score calculation for standardized errors (e.g., when considering accuracy of predictions), and/or involve other computationally expensive processes such as statistical analysis of multi-dimensional vectors on an ongoing basis for anomaly detection, but these existing techniques are limited in many ways as described below.

U.S. Patent Publication No. 2020/0285997 describes a technique for near real-time detection and classification of machine anomalies using machine learning, and involves the use of machine learning based classification, k-NN, and z scores. However, using a machine learning model to classify anomalous data generally involves acquiring large amounts of labeled training data that is specific to a particular system or environment, which is expensive, time-consuming, and utilizes large amounts of computing resources for training data generation and the training itself. Additionally, k-NN often performs poorly when applied to high-dimensional data, which is common in data captured by sensors associated with many types of systems. Furthermore, using z scores for determining standardized errors in the context of assessing the accuracy of predictions involves the use of predictive models to generate the predictions, which also involve generating and using extensive training data, which is expensive, time-consuming, and resource-intensive.

U.S. Patent Publication No. 2020/0285997 describes autonomous predictive real-time monitoring of faults in process and equipment, and involves training a plurality of specific models for predicting key performance indicators (KPIs) and analyzing residuals of predicted KPIs compared to actual KPIs. However, such a technique involves prediction of KPIs and associated costs and inefficiencies related to obtaining and using training data to train one or more predictive models for such a purpose.

U.S. Pat. No. 10,738,230 describes an anomaly detection process for machine tool operations involving the creation of self-organizing maps to generate and analyze a multi-dimensional grid in combination with determining Mahalnobis distances of multidimensional vectors. Such a technique involves warping of data relating to specific machine tool operations to create a multi-dimensional grid and then analyzing the multi-dimensional grid to detect anomalies, which may involve significant computing resources.

U.S. Patent Publication No. 2017/0372207 describes an anomaly detection technique for non-stationary data that involves modifying outliers in a training time series and computing Mahalanobis distances between actual and predicted data. However, such techniques involve time-series based prediction of values based on training data, which is expensive, time-consuming, and resource-intensive.

U.S. Patent Publication No. 2016/0342903 describes a machine sensor data anomaly detection technique involving k-means and Mahalanobis distances for clustering in order to detect anomalies. However, this technique involve complex event processing in order to analyze streams of event data, which can be computationally expensive. Furthermore, performing k-means and Mahalanobis distance computations to cluster data on an ongoing basis can be computationally expensive.

U.S. Pat. No. 10,738,230 describes an anomaly detection process for energy consumption data involving the use of k-NN for clustering. However, as discussed above, k-NN often performs poorly when applied to high-dimensional data, which is common in data captured by sensors associated with many types of systems.

U.S. Pat. No. 10,915,602 describes an anomaly detection process involving computing Mahalanobis distances for individual data elements in streams of multivariate data and the use of a modified z-score and an x-score based on whether a probability distribution is expected to be normal. However, computing Mahalanobis distances for each individual data element of a multivariate data stream over time is computationally expensive. Furthermore, techniques involving the use of a modified z-score and an x-score based on whether a probability distribution is expected to be normal involve determining expectations about whether distributions will be normal.

U.S. Pat. No. 10,274,690 describes a machine learning technique for predictive labeling of whether values are permissible for particular variables. However, as discussed above, using a machine learning model to classify data as permissible or impermissible generally involves acquiring large amounts of labeled training data that is specific to a particular system or environment, which is expensive, time-consuming, and utilizes large amounts of computing resources for training data generation and the training itself.

Patent Cooperation Treaty (PCT) Publication No, WO2022259100A1 describes a technique for using machine learning to learn the interactions between two or more different properties and then using the learned interactions to take action to improve an engineered word product, such as using recommended parameter values determined using machine learning. However, such techniques involve the training of a machine learning model with extensive amounts of training data and using the machine learning model on an ongoing basis to determine recommended parameter values, which is computationally expensive.

Existing techniques such as those discussed above are limited in various ways, such as being computationally expensive and not being tailored well for analysis of large amounts of multivariate data that is captured on an ongoing basis. Furthermore, these techniques may fail to recognize more complex or nuanced conditions that should be addressed in order to improve performance, may be inefficient, may expend computing resources analyzing data that is irrelevant, insignificant, or misleading, and may be unable to automatically recognize useful indicators among the large amounts of data captured in many types of systems.

Therefore, there is a need in the art for improved techniques of automated analysis of data relating to performance of a system.

### SUMMARY

The embodiments described herein generally relate to techniques for automated performance analysis of a system. Embodiments include: receiving a data set comprising parameter values for a plurality of parameters captured during a time period by a plurality of sensor devices associated with the system; providing inputs based on the data set to a supervised machine learning model configured to determine significant parameters in an input data set with respect to a target variable; receiving, from the supervised machine learning model in response to the inputs, an indication of two or more significant parameters from the plurality of parameters with respect to the target variable; generating a multivariate cluster for the target variable based on a subset of the parameter values that corresponds to the two or more significant parameters, the multivariate cluster for the target variable excluding parameter values in the subset of the parameter values that are temporally associated with a certain value range for the target variable; and determining an anomalous state of the system with respect to the target variable based on the multivariate cluster for the target variable and data captured after the time period.

Further embodiments include a non-transitory computer-readable storage medium storing instructions that, when executed by a computer system, cause the computer system to perform the method set forth above. Further embodiments include a system comprising at least one memory and at least one processor configured to perform the method set forth above.

The features, functions, and advantages that have been discussed can be achieved independently in various embodiments or may be combined in yet other embodiments, further details of which can be seen with reference to the following description and drawings.

### BRIEF DESCRIPTION OF THE DRAWINGS

So that the manner in which features of the present disclosure can be understood in detail, a more particular description of the disclosure, briefly summarized above, may be had by reference to embodiments thereof, some of which are illustrated in the appended drawings that form a part of this specification. It is to be noted, however, that the appended drawings illustrate only exemplary embodiments and are therefore not to be considered limiting of its scope as the exemplary embodiments may admit to other equally effective embodiments.

FIG. 1 is an illustration of example computing components related to automated system performance analysis according to at least one embodiment of the present disclosure.

FIG. 2 is an illustration of an example technique for automated system performance analysis according to at least one embodiment of the present disclosure.

FIG. 3 is an illustration of an example user interface screen related to automated system performance analysis according to at least one embodiment of the present disclosure.

FIG. 4 is an illustration of another example user interface screen related to automated system performance analysis according to at least one embodiment of the present disclosure.

FIG. 5 is an illustration of another example user interface screen related to automated system performance analysis according to at least one embodiment of the present disclosure.

FIG. 6 is an illustration of another example user interface screen related to automated system performance analysis according to at least one embodiment of the present disclosure.

FIG. 7 is an illustration of another example user interface screen related to automated system performance analysis according to at least one embodiment of the present disclosure.

FIG. 8 is an illustration of another example user interface screen related to automated system performance analysis according to at least one embodiment of the present disclosure.

FIG. 9 is an illustration of another example user interface screen related to automated manufacturing system performance analysis according to at least one embodiment of the present disclosure.

FIG. 10 is an illustration of another example user interface screen related to automated system performance analysis according to at least one embodiment of the present disclosure.

FIG. 11 is an illustration of another example user interface screen related to automated system performance analysis according to at least one embodiment of the present disclosure.

FIG. 12 is an illustration of another example user interface screen related to automated system performance analysis according to at least one embodiment of the present disclosure.

FIG. 13 is an illustration of example operations related to automated system performance analysis according to at least one embodiment of the present disclosure.

FIG. 14 is an illustration of an example computing system related to automated system performance analysis according to at least one embodiment of the present disclosure.

### DETAILED DESCRIPTION

Embodiments of the present disclosure generally relate to automated analysis of system performance, such as for components of a manufacturing system or other type of system. According to various embodiments described herein, multivariate data is captured via sensors as one or more processes are performed, and is analyzed in a particular dynamic manner in order to automatically identify anomalous system states with respect to particular target variables.

For example, a target variable may be a productivity feature such as forming line speed, delamination (e.g., a measure of downgrades), throughput, combinations thereof, among other suitable features and suitable productivity features. More generally, a target variable represents a performance-related feature that an operator of a system may track in order to determine how well the system is functioning. Techniques described herein can involve using supervised machine learning to determine which system attributes are significant (or important) to a particular target variable, and then using historically captured values for those significant attributes to generate a multivariate baseline for the particular target variable. The multivariate baseline may include, for example, a mean vector and a covariance matrix determined based on a multivariate data cluster that includes a plurality of multivariate points. In certain embodiments, configured acceptable and unacceptable value ranges for the particular target variable are used to dynamically exclude parameter values from the multivariate data cluster that is used for the multivariate baseline calculation, such as excluding parameter values (e.g., for parameters other than the target variable) that are temporally associated with unacceptable values for the target variable. It is noted that acceptable or unacceptable values or value ranges refer to values or value ranges that have been denoted as acceptable or unacceptable by a user, such as via configuration information.

Once determined, a multivariate baseline for the system can be used to determine whether future states of the system are anomalous, such as based on subsequent values captured (e.g., in real time) for the significant parameters with respect to the target variable. For example, a modified Mahalanobis distance may be calculated. Mahalanobis distance generally measures the distance between two points in multivariate space, such as the distance of a given multivariate point (e.g., representing a set of values captured in real time for significant parameters) relative to a centroid such as a base or central point that is representative of a mean of a multivariate data set (e.g., representing a system baseline). According to embodiments of the present disclosure, a Mahalanobis distance computation may be “modified” such that the computation involves only parameters determined to be significant to a target variable (e.g., determined using a supervised machine learning model as described herein) and in that the system baseline data set (e.g., a data cluster of which a centroid is determined by determining a mean vector) includes only parameter values that are temporally associated with “acceptable” values for the target variable (e.g., based on configured acceptable and unacceptable value ranges for the target variable). Furthermore, the Mahalanobis distance computation may be modified in the sense that the multivariate point being compared to the centroid is not included in the multivariate data set that is used to compute the centroid. For example, while a conventional Mahalanobis distance represents a distance from a given multivariate point to a centroid of a data set that includes the given multivariate point, the modified Mahalanobis distance computation described herein generally refers to a distance from a given multivariate point to a centroid of a data set that does not include the given multivariate point and that instead represents a multivariate baseline to which subsequent data points are compared. These modifications produce a Mahalanobis distance computation that is more dynamically tailored to multivariate analysis of performance-related data, such as when analyzing data related to specific target variables. Excluding parameters that are not determined to be significant to a target variable and excluding parameter values that are temporally associated with unacceptable values for the target variable improves the accuracy of determinations made based on the analysis and also improves the functioning of computing devices involved by reducing the amount of data that is stored and processed in connection with such analysis, thereby reducing the amounts of computing resources utilized. Furthermore, excluding the multivariate point being compared to the centroid from the multivariate data set that is used to compute the centroid allows the modified Mahalanobis distance computation described herein to be performed in a resource-efficient manner on an ongoing basis without re-computing the centroid for every Mahalanobis distance computation, thereby improving resource-efficiency and the functioning of the computing devices involved. For example, while conventional techniques for computing Mahalanobis distances (e.g., those described above in the background section) involve computing a covariance matrix (or an inverse of a covariance matrix) every time a Mahalanobis distance is determined, which is computationally expensive, the modified Mahalanobis distance computations described herein involve computing the covariance matrix (or the inverse of the covariance matrix) only once or periodically (e.g., to determine a multivariate system baseline initially and/or at regular intervals) but not every time a Mahalanobis distance is determined (e.g., because the multivariate point being compared to the multivariate baseline is not included in the multivariate baseline according to techniques described herein), thereby significantly reducing the amount of computational resources utilized compared to existing techniques.

It is noted that references to a centroid herein generally refer to a mean vector determined from a cluster of multivariate points. A covariance matrix is also computed from the cluster of multivariate points, and is used in computing a modified Mahalanobis distance between a given multivariate point and the mean vector. The mean vector and covariance matrix may be referred to collectively as a multivariate baseline.

It is noted that while certain embodiments are described with respect to Mahalanobis distance computations, other implementations are possible. For example, once a cluster of multivariate points is determined as described herein (e.g., excluding parameters that are not determined to be significant to a target variable and excluding parameter values that are temporally associated with unacceptable values for the target variable), a subsequent multivariate point may be compared to the cluster of multivariate points using a variety of different techniques, such as computing a Euclidian distance (or other type of distance) between the subsequent multivariate point and a centroid (or other point) of the cluster of multivariate points.

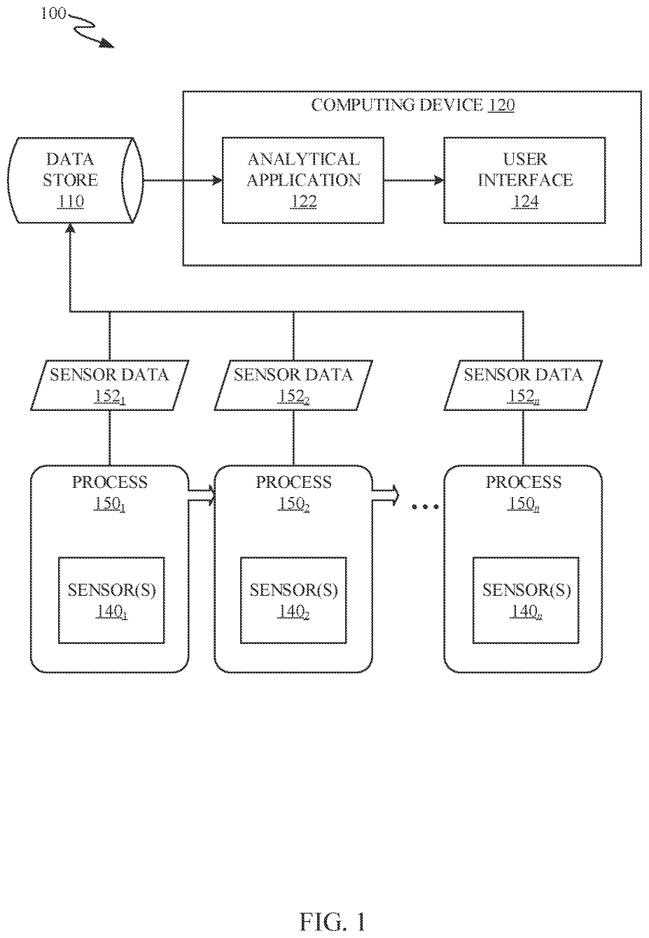

Embodiments of the present disclosure can utilize multivariate statistical techniques to summarize system performance into a single element that is readily identified as indicating normal or abnormal operation. As described in more detail below with respect to FIG. 1, sensor data related to a series of processes may be captured in a system such as a manufacturing system, and may be used to perform multivariate performance analysis techniques described herein.

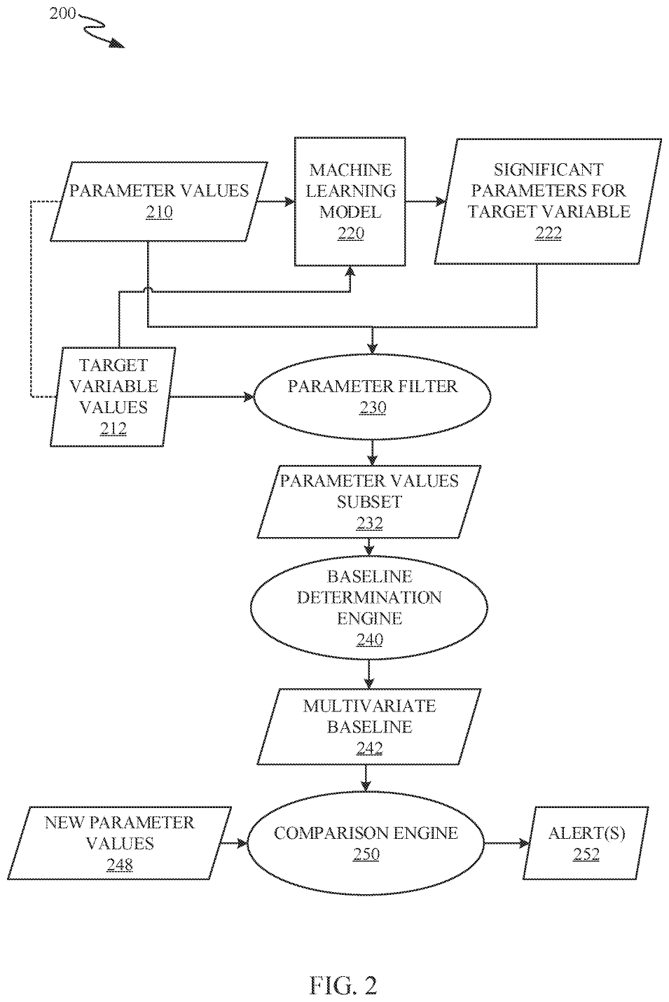

In a non-limiting example, the system is for a mill that produces engineered wood products through the operation of various components that are associated with sensors. The sensors capture values of parameters related to the functioning of the components and the products produced by the components as various processes are carried out. As described in more detail below with respect to FIG. 2, supervised machine learning techniques such as a random forest model, boosted tree model, principal component analysis (PCA), or another suitable technique may be used to determine which parameters are significant to a given target variable, and those significant parameters may be used to determine a multivariate baseline for the system with respect to the given target variable. The multivariate baseline may be updated periodically, such as at regular intervals or whenever some condition is met, to ensure an up-to-date baseline for comparison. Once the multivariate baseline is determined, data may be captured by the sensors on an ongoing basis, such as during ongoing processing within the system, and captured data relating to the significant parameters for the target variable may be used to determine multivariate points (e.g., vectors) to compare to the multivariate baseline.

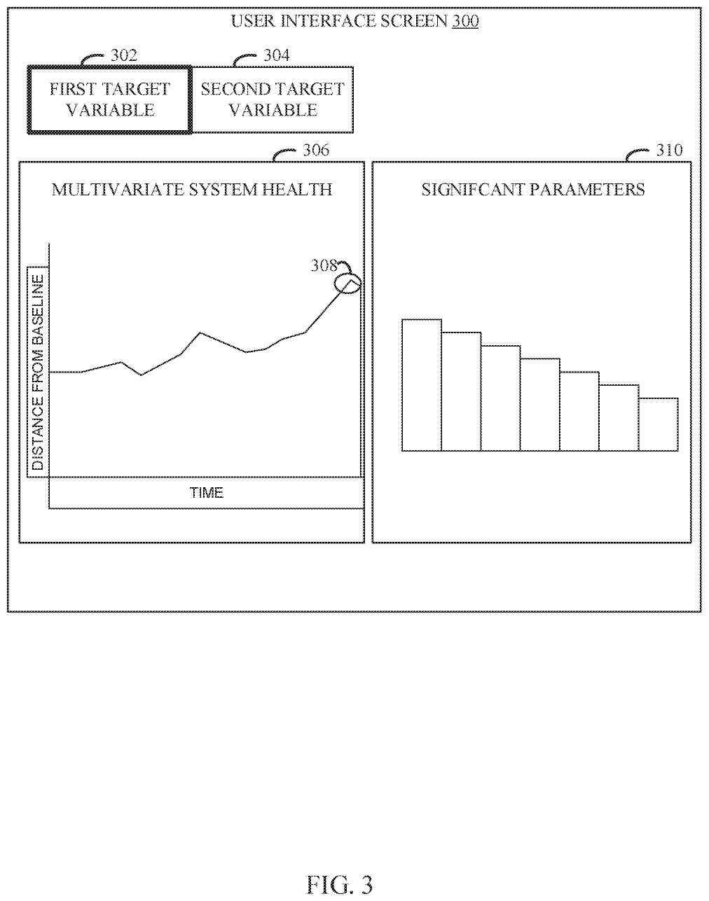

When a given multivariate point is more than a threshold distance away from a mean vector that is part of the multivariate baseline (e.g., the distance may be a modified Mahalanobis distance computed using a covariance matrix that is also part of the multivariate baseline), an anomalous state may be determined. As described in more detail below with respect to FIGS. 3-12, a user interface may display information related to system performance, including alerts regarding anomalous states that are determined using automated analysis techniques described herein. For example, a user interface screen may display visual depictions of distances from each of a plurality of successive points (e.g., representing multivariate system states) to a point representative of a system baseline, and may display indications of distances over a threshold, such as using color, text, or other suitable visual indicators. The user interface may allow a user to select certain aspects of the displayed information in order to view additional detail, such as to observe the particular values for the significant parameters that contributed to a particular multivariate point.

In contrast to conventional techniques for automatically analyzing data captured by sensors associated with systems, embodiments described herein can recognize complex or nuanced conditions to be addressed in order to improve performance. Further, and unlike conventional techniques, embodiments described herein can allow for accurate automated identification of anomalous system states with respect to a particular target variable, such as in real-time, in a manner that is dynamically focused on parameters that are most relevant to the target variable and with reference to a multivariate baseline that is dynamically focused on relevant parameters and relevant parameter values that represent a correctly functioning system with respect to the target variable. While conventional techniques are able to identify individual anomalous parameters, embodiments described herein can provide dynamic system-level multivariate performance analysis based on data selected and processed in a targeted manner with respect to particular performance features, and thereby can provide improved automated insight and performance. Furthermore, by using a modified Mahalanobis distance that does not include the multivariate point that is compared to the mean vector in the cluster of multivariate points used to determine the mean vector and covariance matrix, embodiments of the present disclosure provide further efficiencies in time and computing resource utilization by avoiding the need to compute a mean vector and covariance matrix for every distance determination. Rather, according to embodiments of the present disclosure, a multivariate baseline is computed based on a fixed cluster of multivariate points determined to represent a correctly functioning system with respect to a target variable, and that multivariate baseline is compared to multivariate points representing subsequent system states (e.g., the subsequent multivariate points are not included in the fixed cluster) without the need to re-compute the multivariate baseline for each comparison (e.g., for each modified Mahalanobis distance computation). In some cases, the multivariate baseline is re-computed at suitable intervals, such as based on an amount of time, an amount of available data, or some other trigger condition, so that the system is improved on an ongoing basis as new baseline data becomes available.

Additionally, in contrast to existing techniques that use machine learning models to classify values as normal or anomalous, techniques described herein do not require obtaining large amounts of labeled training data for a specific system or using such training data to train machine learning models for such data classification, thereby avoiding the large amounts of expense in computing resources and time associated with such existing techniques while achieving a high level of accuracy and efficiency in system-level multivariate performance analysis. Furthermore, certain embodiments described herein utilize machine learning only for identifying significant parameters for a given target variable, and not for classifying data as normal or anomalous, and so do not involve the use of machine learning models (and the associated computing resource cost) for every determination of whether a multivariate point is anomalous, but only for selecting significant parameters when determining a multivariate baseline that may be used as a comparison point for many subsequent multivariate points. Thus, compared to techniques that use machine learning models to classify values as normal or anomalous, embodiments described herein utilize substantially fewer computing resources and function in a significantly more efficient manner.

FIG. 1 is an illustration 100 of example computing components related to automated system performance analysis.

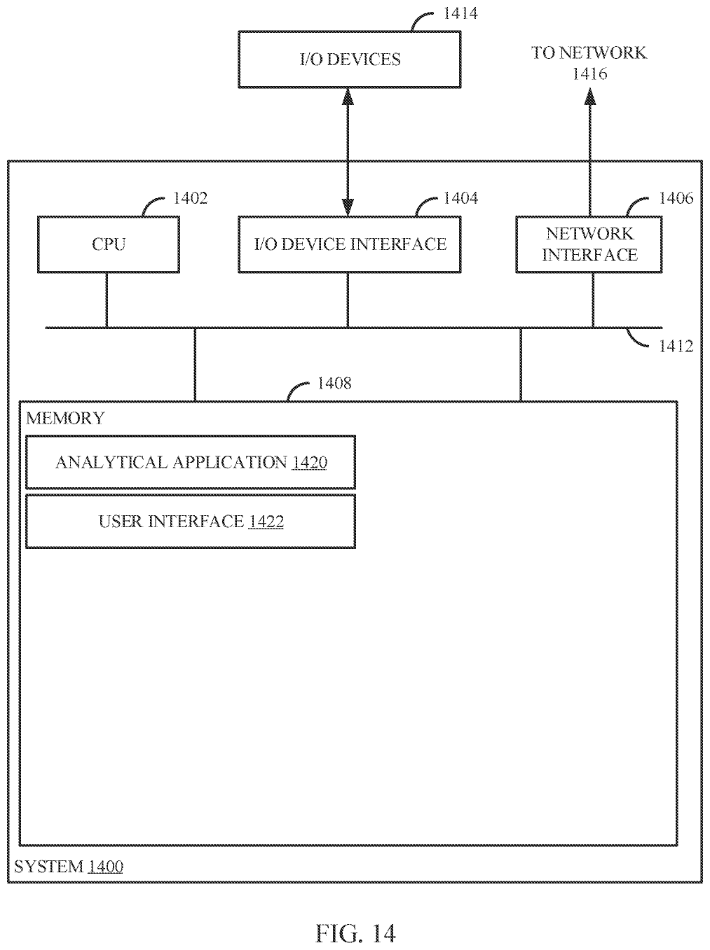

In illustration 100, a computing device 120 includes an analytical application 122 and a user interface 124. Computing device 120 generally represents any suitable type of device on which computing applications may run, such as a server computer, personal computer, mobile device, combinations thereof, among other suitable devices. In some embodiments, computing device 120 comprises one or more processors, one or more storage devices, one or more network interfaces, one or more input/output (I/O) devices, or combinations thereof, among other suitable elements. An example of a computing device is shown with respect to FIG. 14.

Analytical application 122 generally represents a computing application that performs operations related to automated analysis of data related to performance of a system. For example, analytical application 122 may perform operations described herein for determining a multivariate baseline with respect to a target variable and comparing multivariate points to the multivariate baseline in order to identify anomalous system states with respect to the target variable.

User interface 124 generally represents a user-facing component of analytical application 122, such as for displaying output and receiving user input related to automated analysis performed by analytical application 122. Examples of user interface screens of user interface 124 are shown in FIGS. 3-12.

A data store 110 in illustration 100 generally represents a data storage entity such as a database or repository that stores values captured during processing within a system. For example, a series of processes 150₁₋ₙ (collectively processes 150) generally represent operations that are performed in a system in order to accomplish some result, such as manufacturing of a product, and may involve the operation of one or more system components, such as devices that perform different manufacturing operations. One or more sensors 140₁₋ₙ (collectively, sensors 140) are associated with processes 150, such as measuring values related to the operation of one or more devices during processes 150, and generate sensor data 152₁₋ₙ (collectively, sensor data 152) representing the measured values. Each of sensors 140₁₋ₙ may include the same or different sensors. For example, each of processes 150₁₋ₙ may represent a different process involving the same or different devices and the same or different sensors. In an example, the system corresponds to a manufacturing system that produces engineered wood products, and processes 150 involve the operation of equipment such as stranders, green bins, dryers, screens, blenders, formers, combinations thereof, among other suitable equipment. In some examples, sensors 140 may capture, as sensor data 152, values of parameters related to the various operations performed by the equipment involved in processes 150, such as values for pressure, temperature, speed, weight, object movement, valve status, operational failures, combinations thereof, among other suitable parameters. Sensor data 152 may also include values for target variables such as forming line speed, delamination, throughput, combinations thereof, among other suitable values.

Sensor data 152 is stored in data store 110 (e.g., the devices associated with processes 150 may transmit sensor data 152 to data store 110 over a network for storage), from which sensor data 152 can be retrieved by or otherwise transmitted to analytical application 122.

As described in more detail below with respect to FIG. 2, analytical application 122 analyzes sensor data 152, which it receives from data store 110. For example, analytical application 122 may use a supervised machine learning model to determine which parameters in sensor data 152 are significant to a target variable, and may use values for those significant parameters from sensor data 152 to generate a multivariate baseline for the system. The multivariate baseline may be, for example, a centroid of a cluster of values for the significant parameters. The cluster of values may in some embodiments exclude values that are temporally associated with configured unacceptable values for the target variable.

Analytical application 122 may then receive subsequent sensor data 152 (e.g., captured after the data used to generate the multivariate baseline), and may generate multivariate points based on the subsequent sensor data 152, such as including values for the significant parameters, for comparison to the multivariate baseline (e.g., using a modified Mahalanobis distance as described herein). Analytical application 122 may determine whether anomalous system states exist based on the comparison, such as if a modified Mahalanobis distance for a given multivariate point exceeds a threshold.

Analytical application 122 generally outputs data related to its analysis, including any suitable alerts that indicate anomalous system states, to user interface 124 for display to a user.

FIG. 2 is an illustration 200 of an example technique for automated system performance analysis. For example, illustration 200 may depict a technique performed by analytical application 122 of FIG. 1.

Parameter values 210 and target variable values 212 generally represent values for parameters and target variables (target variables may also be parameters, but are depicted separately for ease of explanation) indicated in sensor data (e.g., sensor data 152 of FIG. 1) captured via a one or more sensors as operations are performed in a system. Parameter values 210 and target variables values 212 may be in the form of time-series data or otherwise may be associated with indications of times at which certain values were captured. Thus, it may be possible to determine which parameter values 210 are temporally associated with which target variable values 212.

A machine learning model 220 is used to determine significant parameters 222 for the target variable based on parameter values 210 and target variable values 212. For example, machine learning model 220 may be a tree-based model, such as a random forest model, that is configured to determine significant parameters for a target variable based on values of a plurality of parameters associated with values for the target variable. A tree model (e.g., a decision tree) makes a classification by dividing the inputs into smaller classifications (at nodes), which result in an ultimate classification at a leaf. A random forest extends the concept of a decision tree model, except the nodes included in any given decision tree within the forest are selected with some randomness. Thus, random forests may reduce bias and group outcomes based upon the most likely positive responses. Machine learning model 220 may use bagging techniques. Bagging, or bootstrap aggregating, generally involves randomly sampling subsets of a data set, fitting a model to these subsets, and aggregating predictions. In some embodiments, majority voting of predictions produced by a plurality of decision trees is used to determine a final model output. A significant parameter for a target variable generally refers to a parameter that is highly correlated with the target variable, either positively or negatively. For example, if higher or lower values for a given parameter are frequently associated with higher or lower values for the target variable, then the given parameter may be considered a significant parameter for the target variable. A random forest model or other suitable type of machine learning model 220 may identify a particular parameter as either significant or insignificant for a target variable based on inputs that include values for the particular parameter and values for the target variable (e.g., that are temporally associated with the values for the particular parameter). In some embodiments, machine learning model 220 makes a feature importance determination in order to identify significant parameters 222, such as based on which parameters the model splits on most frequently.

It is noted that a random forest model is included as an example of a type of supervised machine learning model that can be used for machine learning model 220, and other techniques may alternatively be used to determine significant parameters 222, such as boosted trees, principal component analysis (PCA), regression models, and/or the like.

Significant parameters 222 for the target variable, parameter values 210, and target variable values 212, are then used by a parameter filter 230 to determine a parameter values subset 232. For example, parameter filter 230 generally represents a component that filters parameter values 210 to produce a parameter values subset 232 that only includes values for significant parameters 222 for the target variable and only includes values for those parameters that are temporally associated with acceptable (e.g., according to configured acceptable and unacceptable value ranges) values for the target variable. Parameter values subset 232 may also include target variable values 212 (e.g., or at least a subset of target variable values 212 that are within a configured acceptable value range). Generally, parameter values subset 232 excludes values from parameter values 210 for parameters that are not included in significant parameters 222 for the target variable and excludes all parameter values that are temporally associated with unacceptable values of the target variable.

Parameter values subset 232 is used by a baseline determination engine 240 to generate a multivariate baseline 242 with respect to the target variable. For example, baseline determination engine 240 may generate a multivariate cluster (e.g., a cluster or cloud of multivariate points, which may be vectors) based on parameter values subset 232, and may determine a central multivariate point of the multivariate cluster (or another multi-variate point may be determined based on the multivariate cluster). In some embodiments, multivariate baseline 242 comprises the central multivariate point of the multivariate cluster or another multivariate point determined based on the multivariate cluster as well as a covariance matrix determined from the multivariate cluster.

Comparison engine 250 uses multivariate baseline 242 to determine whether new parameter values 248, which may be captured in real-time, are anomalous. For example, new parameter values 248 may be new values captured for the significant parameters 222 for the target variable. In some embodiments, comparison engine 250 performs a modified Mahalanobis distance computation between new parameter values 248 and a mean vector included in multivariate baseline 242 in order to determine whether new parameter values 248 are anomalous. The modified Mahalanobis distance computation may involve determining a multivariate centroid (e.g., mean vector) of the multivariate cluster and determining a covariance matrix (e.g., in some embodiments, an inverse covariance matrix), and computing a Mahalonobis distance between a multivariate point in new parameter values 248 and the multivariate centroid based on the covariance matrix. As described above, the Mahalanobis distance computation is “modified” in the sense that that the computation involves only parameters determined to be significant to the target variable, in that the system baseline data set (e.g., of which a centroid is determined) includes only parameter values that are temporally associated with “acceptable” values for the target variable (e.g., based on configured acceptable and unacceptable value ranges for the target variable), and in that the multivariate point from new parameter values 248 is not included in the system baseline data set.

Comparison engine 250 may generate one or more alerts 252 if it determines that new parameter values 248 are anomalous as compared to multivariate baseline 242. For example, if the modified Mahalanobis distance between multivariate baseline 242 and a given multivariate point indicated in new parameter values 248 exceeds a threshold, then the given multivariate point may be determined to be anomalous, and an alert 252 may be generated. More generally, comparison engine 250 may output indications of distances between multivariate points indicated in new parameter values 248 and multivariate baseline 242, and these distances (and, as appropriate, alert(s) 252) may be displayed via a user interface. Examples of such a user interface are described below with respect to FIGS. 3-12.

The process described herein may be repeated for each of multiple target variables. The significant parameters for one target variable may be different than the significant parameters for another target variable. Furthermore, different parameter values may be excluded from the baselines for different target variables based on temporal associations with acceptable and unacceptable values for the different target variables. Thus, a set of parameter values determined to be anomalous with respect to one target variable may not be determined to be anomalous with respect to another target variable.

It is noted that the particular components depicted and described herein are included as examples, and techniques described herein may be performed by more or fewer components running on one or multiple computing devices.

FIG. 3 depicts an example user interface screen 300 related to automated system performance analysis. For example, user interface screen 300 may correspond to user interface 124 of FIG. 1.

User interface screen 300 includes user interface controls 302 and 304 that allow the user to select between two different target variables. Depending on which target variable is selected, information for that target variable will be displayed in user interface screen 300. For example, because user interface control 302 has been selected, indicating a first target variable, information for the first target variable is displayed in user interface screen 300.

A panel 306 depicts multivariate system health in the form of a graph that represents distance of a multivariate system state from a baseline over time. For example, the multivariate system state may correspond to new parameter values 248 of FIG. 2, the baseline may correspond to multivariate baseline 242 of FIG. 2, and the distance may correspond to a modified Mahalanobis distance computed by comparison engine 250 of FIG. 2.

A graphical indicator 308 in panel 306 indicates that the distance from the baseline at one point in time exceeds a threshold, and so the multivariate system state at that time has been determined to be anomalous. Graphical indicator 308 may be an example of an alert 252 of FIG. 2.

A separate panel 310 displays a chart indicating values of significant parameters for the selected target variable, such as at a particular point in time (e.g., panel 310 may depict modified Mahalanobis distances of the individual significant parameters with respect to the multivariate baseline). In some embodiments, the values depicted in panel 310 are based on which point in time the user has selected within panel 306. For example, if the user selects graphical indicator 308 within the graph in panel 306, the values of significant parameters at the particular point in time corresponding to that point in the graph in panel 306 may be displayed within panel 310. Thus, panel 310 may provide a more detailed view of the multivariate system state with respect to a target variable at a particular point in time as compared to panel 306, which may provide a higher level view of the multivariate system state relative to a baseline over a time period.

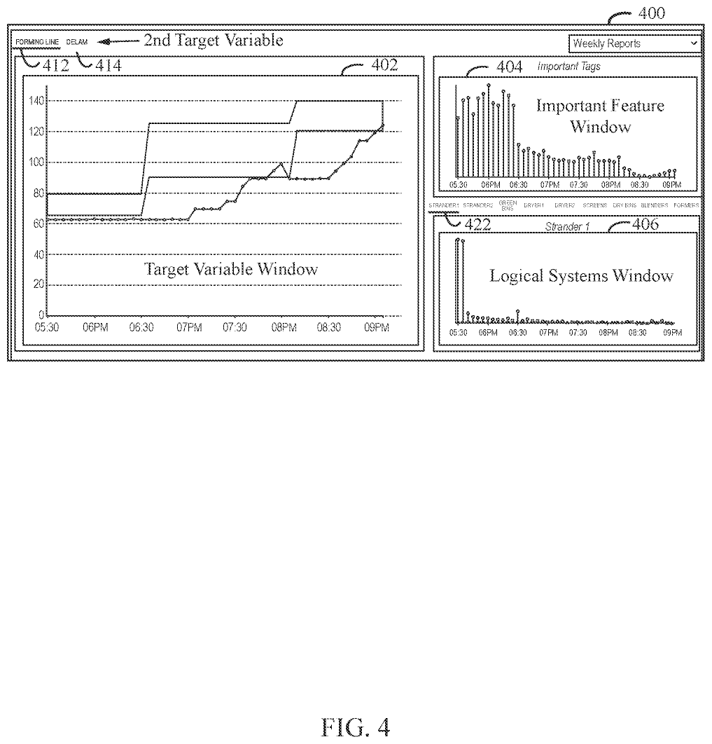

FIG. 4 depicts another example user interface screen 400 related to automated system performance analysis. For example, user interface screen 400 may correspond to user interface 124 of FIG. 1.

User interface screen 400 includes user interface controls 412 and 414 for selecting between two target variables (forming line speed and delamination). A target variable may also be referred to as a productivity feature. A panel 402 depicts a graph representing the distance of a multivariate system state from a baseline over time. Panel 402 may be similar to panel 306 of FIG. 3, but with a more particular example. Panel 404 (which may be similar to panel 310 of FIG. 3) displays a chart representing values of significant parameters (which may also be referred to as important features) for the selected target variable (e.g., forming line speed) at a particular point in time, such as at a time selected by a user via panel 402 (e.g., panel 404 may depict modified Mahalanobis distances of the individual significant parameters with respect to the multivariate baseline). In some embodiments, panel 404 may contain a summary of performance of the significant parameters up to one hour upstream of the target variable.

Another panel 406 depicts parameter values with respect to particular logical systems within the environment (e.g., manufacturing environment), where different logical systems can be selected via a user interface controls such as user interface control 422. For example, in a manufacturing environment, the logical systems may include stranders, green bins, dryers, screens, dry bins, blenders, formers, combinations thereof, among other suitable systems. The parameter values depicted in panel 306 may be the parameters that are associated with the logical system that is currently selected. In some embodiments, panel 406 contains summary information about the current condition of each logical process in the production process.

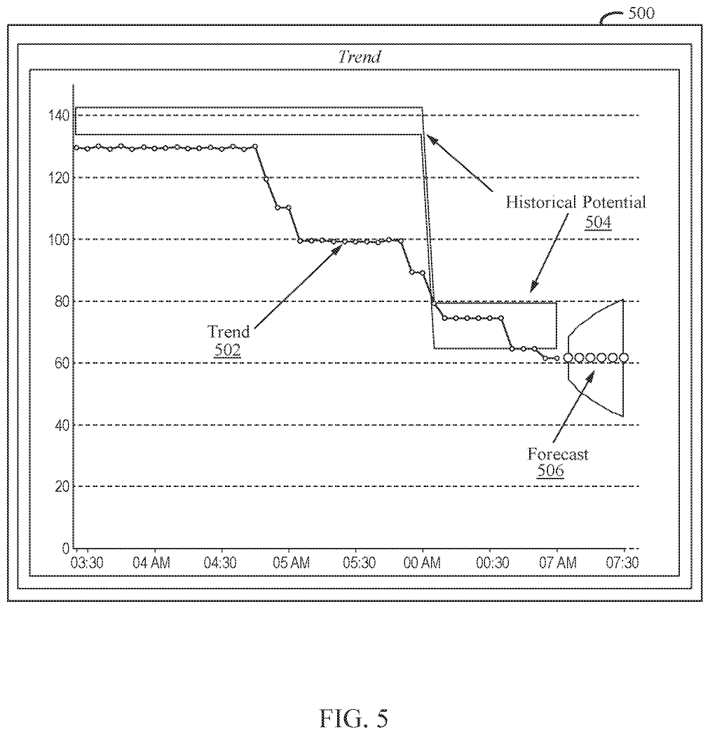

FIG. 5 depicts another example user interface screen 500 related to automated system performance analysis. For example, user interface screen 500 may correspond to user interface 124 of FIG. 1.

User interface screen 500 may represent another example of a target variable window or productivity feature window, such as corresponding to panel 306 of FIG. 3 and panel 402 of FIG. 4. For example, user interface screen 500 may include information about a single target variable, including a historical trend 502 of the target variable as well as the historical potential band 504 and the forecast 506 for a future time period, such as the next thirty minutes, for the target variable.

The historical potential band 504 shows historical performance for the combination of significant parameters that are present in the system. The values represented in historical potential band 504 are values captured after the values used to determine a multivariate baseline. The band width in the depicted example is from the 50th percentile to the 90th percentile of historical performance. The forecast 506 is a prediction of future values for the next 30 minutes based upon time series analysis. Forecast 506 may be generated using time series analysis techniques, such as an autoregressive integrated moving average (ARIMA) model.

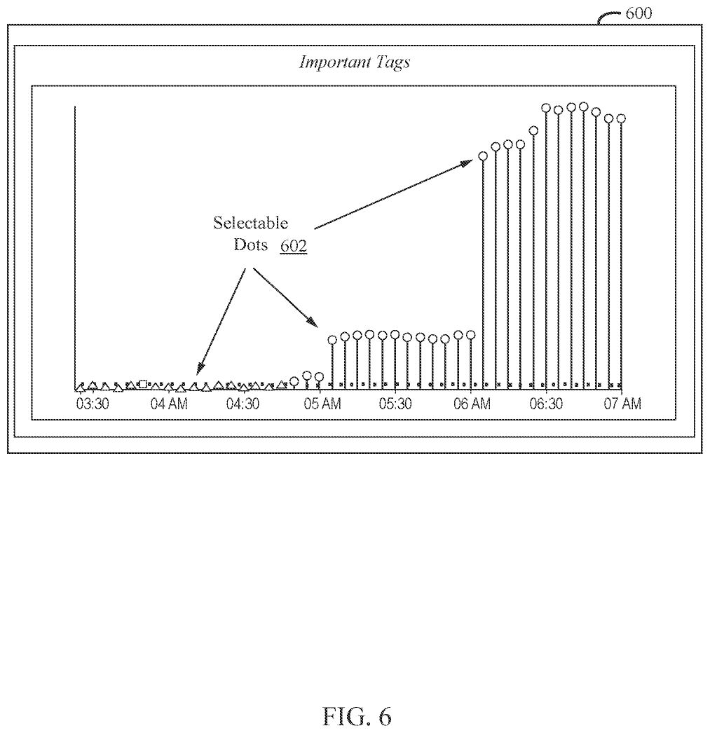

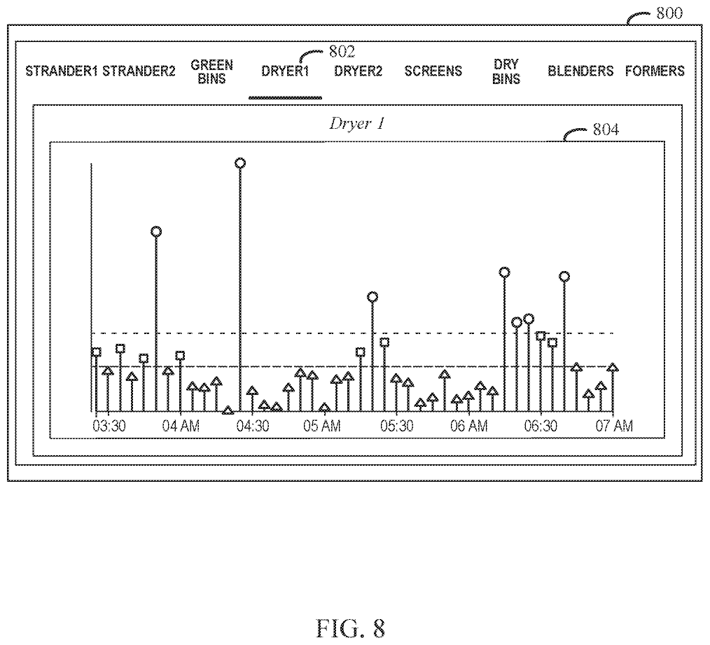

Both the significant parameters window (e.g., panel 310 of FIG. 3, panel 404 of FIG. 4, and/or user interface screen 600 of FIG. 6, discussed below) and logical systems window (e.g., panel 406 of FIG. 4 and user interface screen 800 of FIG. 8, discussed below) contain a single value that is a modified Mahalanobis distance that indicates distance from the multivariate baseline of significant parameters.

A multivariate baseline can be created by combining the most important features for the target variable of interest. The modification to the Mahalanobis distance is based upon selection of the values to be used to create the mean vector and covariance matrix that will be used to calculate the distance. For the target variable, only those instances where the target variable is considered good performance are used. This causes the instances of poor performance to stand out more than if all instances are used to create the reference mean vector and covariance matrix. The most important features are defined by analyzing contributions from a time period (e.g., which may be configurable based on the processes involved) upstream of the target variable (e.g., using machine learning model 220 of FIG. 2). The distance from the centroid of the multi-dimensional data cluster (e.g., the mean vector in the multivariate baseline) is shown in these user interface screens by a line indicating the relative distance. At the end of the line may be a dot or other suitable element that can be clicked on or otherwise selected to show the most significant contributions to the distance.

FIG. 6 depicts another example user interface screen 600 related to automated system performance analysis. For example, user interface screen 600 may correspond to user interface 124 of FIG. 1.

User interface screen 600 may represent another example of a significant parameters window, such as corresponding to panel 404 of FIG. 4. For example, user interface screen 600 may include information about a single target variable, including modified Mahalanobis distances indicating distance from the data cluster (e.g. from the mean vector in the multivariate baseline) of significant parameters for the target variable. The distance from the centroid of the multi-dimensional data cluster (e.g., from the mean vector in the multivariate baseline) is shown in user interface screen 600 by a line indicating the relative distance. At the end of the lines are selectable dots 602 (dots are included as an example of a selectable element) that can be clicked on or otherwise selected to show the most significant contributions to the distance.

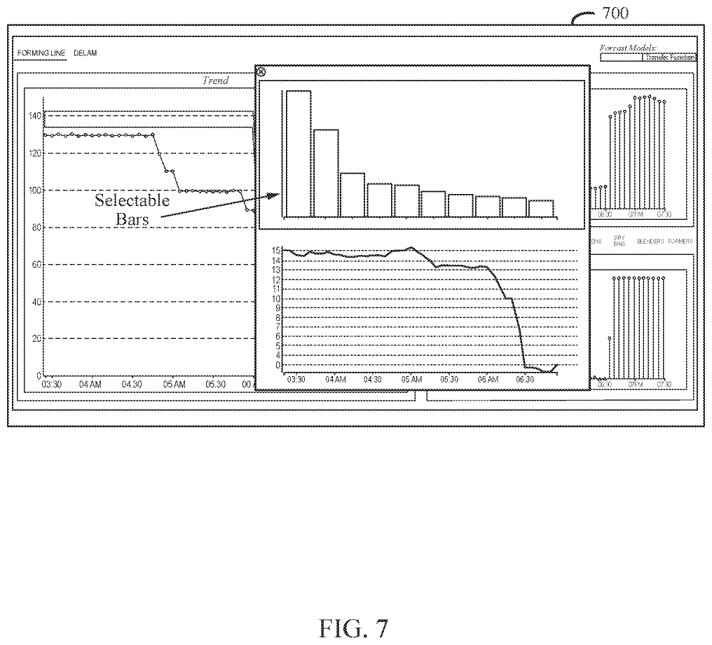

Upon selecting a selectable dot 602, a new window (e.g., user interface screen 700 of FIG. 7, discussed below) may be displayed showing a Pareto chart of the largest contributors to the distance for the selected dot along with the trend of the feature or parameter.

FIG. 7 depicts another example user interface screen 700 related to automated system performance analysis. For example, user interface screen 700 may correspond to user interface 124 of FIG. 1.

User interface screen 700 is an example of a window displaying a Pareto chart and tends of largest contributors to a distance, which may be displayed upon selecting a selectable dot 602 of FIG. 6. A Pareto chart generally contains both bars and lines, where individual values are represented in descending order by bars, and the cumulative total of the sample is represented by the curved line.

Each selectable bar 702 in user interface screen 700 represents a parameter, and can be selected in order to display that parameter's trend (e.g., within user interface screen 700).

FIG. 8 depicts another example user interface screen 800 related to automated system performance analysis. For example, user interface screen 800 may correspond to user interface 124 of FIG. 1.

User interface screen 800 may represent another example of a logical systems window, such as corresponding to panel 406 of FIG. 4. For example, user interface screen 800 may include information about a single target variable and a single logical system, including modified Mahalanobis distances indicating distance from the data cluster (e.g. from the mean vector in the multivariate baseline) of significant parameters for the target variable and relating to the logical system. Different logical systems may be selected via user interface elements, such as user interface element 802, in order to cause information related to a particular logical system (e.g., a particular dryer) to be displayed within panel 804 of user interface screen 800.

The distance from the centroid of the multi-dimensional data cluster (e.g., from the mean vector of the multivariate baseline) is shown in panel 804 of user interface screen 800 by a line indicating the relative distance. At the end of the lines are selectable dots (dots are included as an example of a selectable element) that can be clicked on or otherwise selected to show the most significant contributions to the distance.

Upon selecting a selectable dot, a new window (e.g., similar to user interface screen 700 of FIG. 7, discussed above) may be displayed showing a Pareto chart of the largest contributors to the distance for the selected dot along with the trend of the feature or parameter.

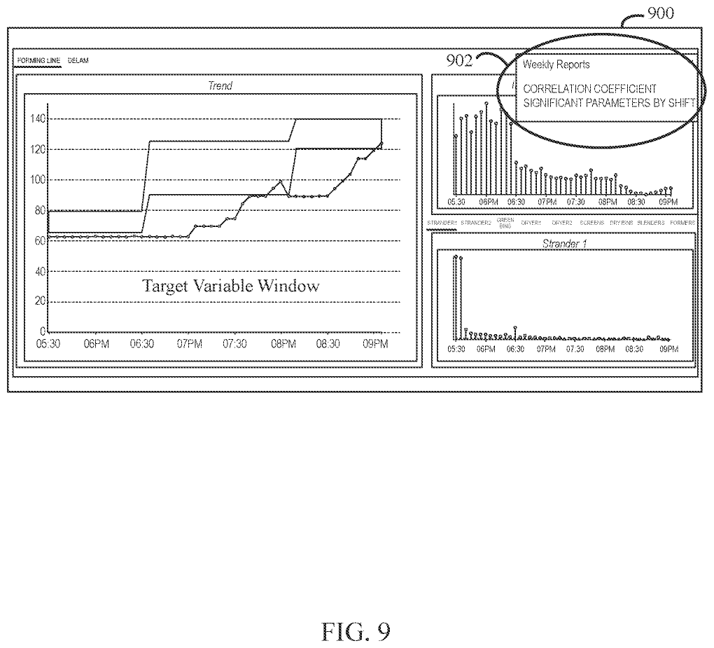

FIG. 9 depicts another example user interface screen 900 related to automated system performance analysis. For example, user interface screen 900 may correspond to user interface 124 of FIG. 1.

User interface screen 900 may represent another example of user interface screen 400 of FIG. 4, except where a menu 902 is displayed, such as after a “weekly reports” element is selected. For example, menu 902 may include options of weekly reports (weekly reports are included as an example, but other suitable periodicities of reports may also be used) that can be displayed for the target variable. Menu 902 includes options to display either correlation coefficient weekly reports or, alternatively, important weekly reports showing features by shift. Other suitable menu options may also be possible, such as set point to actual value comparison weekly reports. Menu 902 can be accessed to understand opportunities for improvement that can be worked on during scheduled downtime.

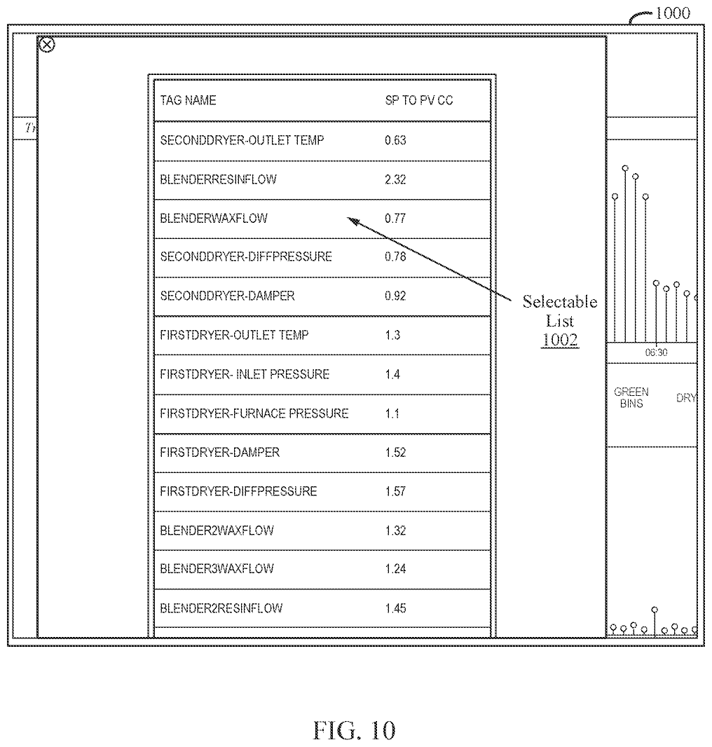

FIG. 10 depicts another example user interface screen 1000 related to automated system performance analysis. For example, user interface screen 1000 may correspond to user interface 124 of FIG. 1.

User interface screen 1000 may represent a window that is displayed after selecting an option from menu 902 of FIG. 9, such as a correlation coefficient weekly report or set point to actual value comparison weekly report. User interface screen 1000 lists the correlation coefficient for operator controllable feature set points (SP) and actual values (Process Values of PV). The selectable list 1002 can be arranged in order from worst to best with any suitable feature having a correlation coefficient less than 0.80 being highlighted in red (color not shown in FIG. 10) or otherwise visually indicated in a first manner and those between 0.8 and 0.9 being highlighted in yellow (color not shown in FIG. 10) or otherwise being visually indicated in a second manner (e.g., different from the first manner). These colors and display conventions are included as examples, and other suitable methods of indicating correlation coefficients are possible.

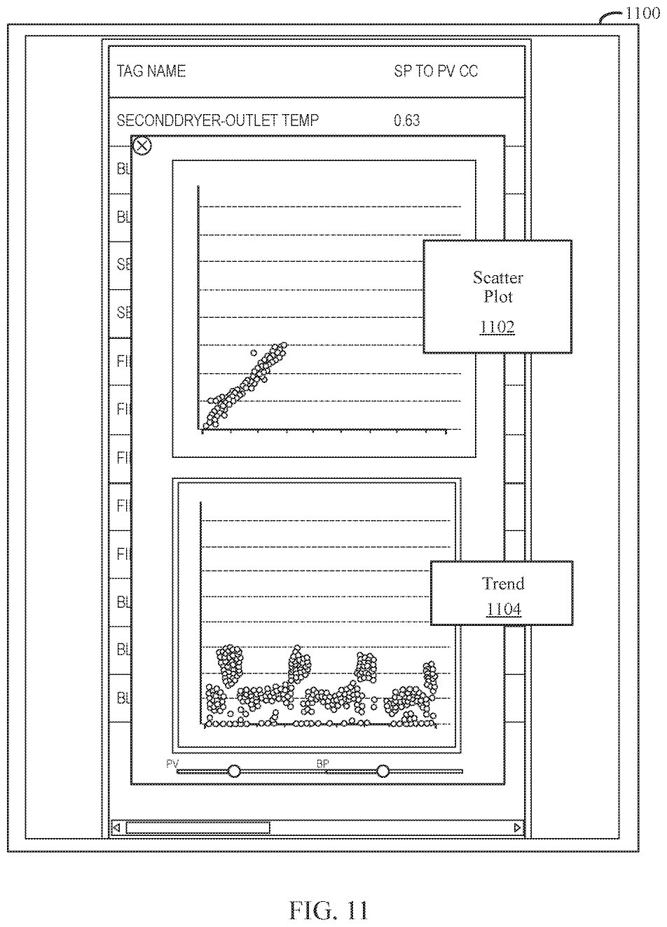

While color is not shown in FIG. 10, selectable list 1002 can indicate the severity of the performance by color coding, for example, with red being worse, yellow being bad, and those that have no highlight as being normal. The items can be selectable and, when selected, may cause a pop-up window to be displayed showing a scatter plot and trend of the selected feature set point and actual value (e.g., user interface screen 1100 of FIG. 11).

FIG. 11 depicts another example user interface screen 1100 related to automated system performance analysis. For example, user interface screen 1100 may correspond to user interface 124 of FIG. 1.

User interface screen 1100 may represent a window that is displayed after selecting an item from selectable list 1002 of FIG. 1. User interface screen 1100 shows a scatter plot 1102 and trend 1104 of the selected feature set point and actual value.

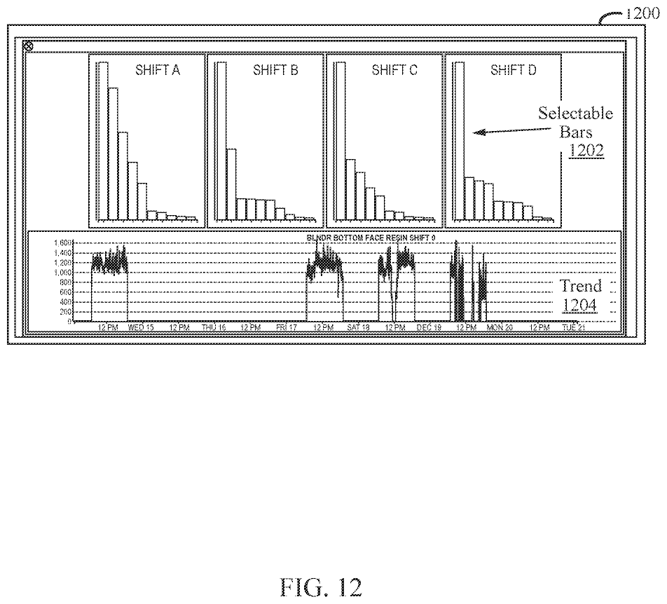

FIG. 12 depicts another example user interface screen 1200 related to automated system performance analysis. For example, user interface screen 1200 may correspond to user interface 124 of FIG. 1.

User interface screen 1200 may represent a window that is displayed after selecting an option from menu 902 of FIG. 9, such as a weekly report showing features by shift. User interface screen 1200 lists the most important contributors to line speed variation (e.g., an example of a target variable) from the previous week across all shifts. Such a list is expected to encourage analysis between the shifts relative to how performance is different and how each shift is reacting to or controlling process variation. User interface screen 1200 includes selectable bars 1202 (e.g., representing features or parameters) that, when selected, cause a trend 1204 for the selected feature to be displayed.

It is noted that the particular user interface screens and elements depicted and described herein are included as examples, and alternative techniques for displaying information determined using techniques described herein are possible.

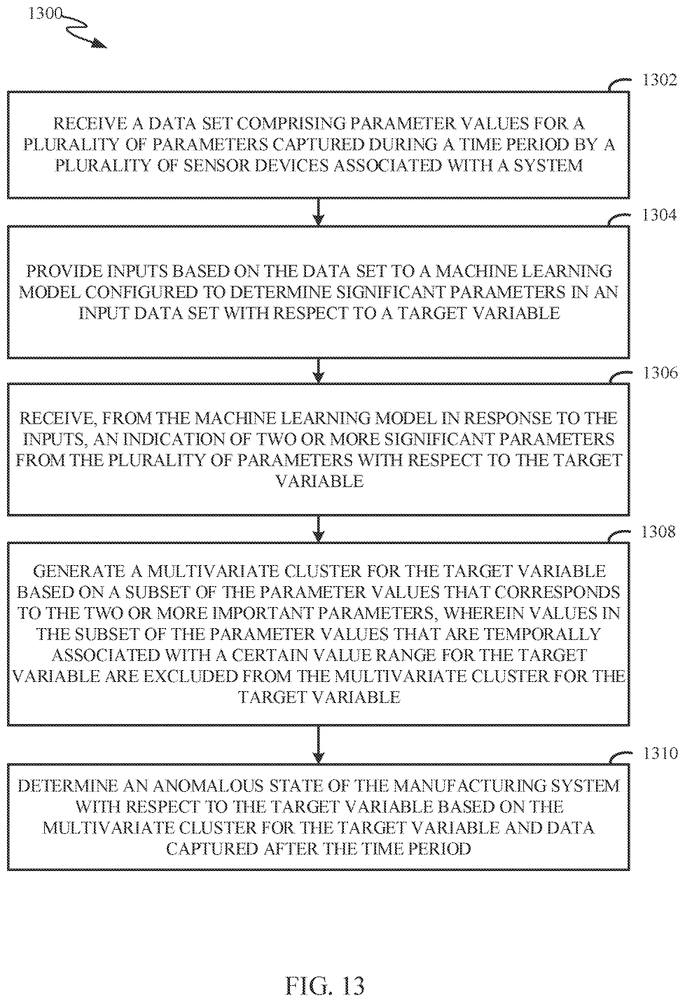

FIG. 13 depicts example operations 1300 related to automated system performance analysis according to embodiments of the present disclosure. For example, operations 1300 may be performed by one or more components described above with respect to FIG. 1 and FIG. 2.

Operations 1300 begin at step 1302, with receiving a data set comprising parameter values for a plurality of parameters captured during a time period by a plurality of sensor devices associated with a system.

Operations 1300 continue at step 1304, with providing inputs based on the data set to a supervised machine learning model configured to determine significant parameters in an input data set with respect to a target variable.

Operations 1300 continue at step 1306, with receiving, from the supervised machine learning model in response to the inputs, an indication of two or more significant parameters from the plurality of parameters with respect to the target variable.

Operations 1300 continue at step 1308, with generating a multivariate cluster for the target variable based on a subset of the parameter values that corresponds to the two or more significant parameters, the multivariate cluster for the target variable excluding parameter values in the subset of the parameter values that are temporally associated with a certain value range for the target variable.

Operations 1300 continue at step 1310, with determining an anomalous state of the system with respect to the target variable based on the multivariate cluster for the target variable and data captured after the time period.

Some embodiments further comprise determining a central vector of the multivariate cluster for the target variable, wherein the determining of the anomalous state of the system with respect to the target variable is based on comparing the data captured after the time period to the central vector. The central vector may, for example, be a mean vector. Alternatively, the central vector may be a median vector. In certain embodiments, the determining of the anomalous state of the system with respect to the target variable is based on determining a Mahalanobis distance for the data captured after the time period based on the central vector and a covariance matrix determined from the multivariate cluster for the target variable.

In some embodiments, the data set includes a time series of values for the target variable associated with a corresponding time series for each of the plurality of parameters.

Certain embodiments further comprise generating a different multivariate cluster for a different target variable based on a different subset of the parameter values that corresponds to a different two or more significant parameters for the different target variable, wherein respective values in the different subset of the parameter values that are temporally associated with a particular value range for the different target variable are excluded from the different multivariate cluster for the different target variable.

Some embodiments further comprise determining the different two or more significant parameters using the supervised machine learning model based on the data set.

In certain embodiments, the certain value range for the target variable represents values configured as problematic for the target variable.

Some embodiments further comprise generating an alert based on the determining of the anomalous state of the system with respect to the target variable.

Certain embodiments further comprise displaying the alert via a user interface. In some embodiments, displaying the alert via the user interface comprises displaying an indication that a distance from a vector representing a particular multivariate state of the system to a central vector of the multivariate cluster for the target variable exceeds a threshold.

Some embodiments further comprise displaying, via the user interface, graphical representations of distances from each of a plurality of vectors representing successive multivariate states of the system to the central vector of the multivariate cluster for the target variable.

Certain embodiments further comprise receiving, via the user interface, a selection of one of the graphical representations and displaying, via the user interface in response to the selection, additional detail relating to individual parameters of a multivariate state represented by the one of the graphical representations.

In some embodiments, the system is a manufacturing system, and the plurality of sensor devices are associated with one or more devices that perform operations related to manufacturing of one or more products. It is noted that manufacturing systems are included as an example, and techniques described herein may be used for other types of continuous or near-continuous processes.

FIG. 14 illustrates an example computing system 1400 with which embodiments of the disclosure related to automated system performance analysis may be implemented. For example, the computing system 1400 may be representative of computing device 120 of FIG. 1.

The computing system 1400 includes a central processing unit (CPU) 1402, one or more I/O device interfaces 1404 that may allow for the connection of various I/O devices 1404 (e.g., keyboards, displays, mouse devices, pen input, etc.) to the computing system 1400, a network interface 1406, a memory 1408, and an interconnect 1412. It is contemplated that one or more components of the computing system 1400 may be located remotely and accessed via a network 1410. It is further contemplated that one or more components of the computing system 1400 may include physical components or virtualized components.

The CPU 1402 may retrieve and execute programming instructions stored in the memory 1408. Similarly, the CPU 1402 may retrieve and store application data residing in the memory 1408. The interconnect 1412 transmits programming instructions and application data, among the CPU 1402, the I/O device interface 1404, the network interface 1406, the memory 1408. The CPU 1402 is included to be representative of a single CPU, multiple CPUs, a single CPU having multiple processing cores, and other suitable arrangements.

Additionally, the memory 1408 is included to be representative of a random access memory or the like. In some embodiments, the memory 1408 may include a disk drive, solid state drive, or a collection of storage devices distributed across multiple storage systems. Although shown as a single unit, the memory 1408 may be a combination of fixed and/or removable storage devices, such as fixed disc drives, removable memory cards or optical storage, network attached storage (NAS), or a storage area-network (SAN).

As shown, the memory 1408 includes analytical application 1420 and user interface 1422, which may be representative analytical application 122 and user interface 124 of FIG. 1.

Thus, embodiments described herein generally relate to techniques for automated system performance analysis. Certain embodiments include: receiving a data set comprising parameter values for a plurality of parameters captured during a time period by a plurality of sensor devices associated with a system; providing inputs based on the data set to a supervised machine learning model configured to determine significant parameters in an input data set with respect to a target variable; receiving, from the supervised machine learning model in response to the inputs, an indication of two or more significant parameters from the plurality of parameters with respect to the target variable; generating a multivariate cluster for the target variable based on a subset of the parameter values that corresponds to the two or more significant parameters, the multivariate cluster for the target variable excluding values in the subset of the parameter values that are temporally associated with a certain value range for the target variable; and determining an anomalous state of the system with respect to the target variable based on the multivariate cluster for the target variable and data captured after the time period. In contrast to conventional techniques for automatically analyzing data captured by sensors associated with systems, embodiments described herein can recognize complex or nuanced conditions to be addressed in order to improve performance. Further, and unlike conventional techniques, embodiments described herein can allow for accurate automated identification of anomalous system states with respect to a particular target variable, such as in real-time, in a manner that is dynamically focused on parameters that are most relevant to the target variable and with reference to a multivariate baseline that is dynamically focused on relevant parameters and relevant parameter values that represent a correctly functioning system with respect to the target variable. While conventional techniques are able to identify individual anomalous parameters, techniques described herein provide dynamic system-level multivariate performance analysis based on data selected and processed in a targeted manner with respect to particular performance features, and thereby provide improved automated insight and performance.

As is apparent from the foregoing general description and the specific embodiments, while forms of the embodiments have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, such as the terms “comprising,” “consisting essentially of,” “consisting of” also include the product of the combinations of elements listed after the term.

As used herein, the indefinite article “a” or “an” shall mean “at least one” unless specified to the contrary or the context clearly indicates otherwise. For example, embodiments comprising “a target variable” includes embodiments comprising one, two, or more target variables, unless specified to the contrary or the context clearly indicates only one target variable is included.

While the foregoing is directed to embodiments of the present disclosure, other and further embodiments of the disclosure may be devised without departing from the basic scope thereof, and the scope thereof is determined by the claims that follow.

What is claimed is:

1. A method for automated performance analysis of a system, the method comprising:
receiving a data set comprising parameter values for a plurality of parameters captured during a time period by a plurality of sensor devices associated with the system;
providing inputs based on the data set to a supervised machine learning model configured to determine significant parameters in an input data set with respect to a target variable;
receiving, from the supervised machine learning model in response to the inputs, an indication of two or more significant parameters from the plurality of parameters with respect to the target variable;
generating a multivariate cluster for the target variable based on a subset of the parameter values that corresponds to the two or more significant parameters, the multivariate cluster for the target variable excluding parameter values in the subset of the parameter values that are temporally associated with a certain value range for the target variable; and
determining an anomalous state of the system with respect to the target variable based on the multivariate cluster for the target variable and data captured after the time period.

2. The method of claim 1, further comprising determining a central vector of the multivariate cluster for the target variable, wherein the determining of the anomalous state of the system with respect to the target variable is based on comparing the data captured after the time period to the central vector.

3. The method of claim 2, wherein the determining of the anomalous state of the system with respect to the target variable is based on determining a Mahalanobis distance for the data captured after the time period based on the central vector and a covariance matrix determined from the multivariate cluster for the target variable.

4. The method of claim 1, wherein the data set includes a time series of values for the target variable associated with a corresponding time series for each of the plurality of parameters.

5. The method of claim 1, further comprising generating a different multivariate cluster for a different target variable based on a different subset of the parameter values that corresponds to a different two or more significant parameters for the different target variable, wherein respective values in the different subset of the parameter values that are temporally associated with a particular value range for the different target variable are excluded from the different multivariate cluster for the different target variable.

6. The method of claim 5, further comprising determining the different two or more significant parameters using the supervised machine learning model based on the data set.

7. The method of claim 1, wherein the certain value range for the target variable represents values configured as problematic for the target variable.

8. The method of claim 1, further comprising generating an alert based on the determining of the anomalous state of the system with respect to the target variable.

9. The method of claim 8, further comprising displaying the alert via a user interface.

10. The method of claim 9, wherein displaying the alert via the user interface comprises displaying a respective indication that a distance from a vector representing a particular multivariate state of the system to a central vector of the multivariate cluster for the target variable exceeds a threshold.

11. The method of claim 10, further comprising displaying, via the user interface, graphical representations of respective distances from each of a plurality of vectors representing successive multivariate states of the system to the central vector of the multivariate cluster for the target variable.

12. The method of claim 11, further comprising:
receiving, via the user interface, a selection of one of the graphical representations; and
displaying, via the user interface in response to the selection, additional detail relating to individual parameters of a multivariate state represented by the one of the graphical representations.

13. The method of claim 1, wherein the system is a manufacturing system, and wherein the plurality of sensor devices are associated with one or more devices that perform operations related to manufacturing of one or more products.

14. The method of claim 1, wherein the system is a mill that produces an engineered wood product, and wherein the plurality of sensor devices are associated with one or more devices that perform operations related to manufacturing of the engineered wood product.

15. A computing system for automated performance analysis of a system, the system comprising:
one or more processors; and
a memory comprising instructions that, when executed by the one or more processors, cause the computing system to:
receive a data set comprising parameter values for a plurality of parameters captured during a time period by a plurality of sensor devices associated with the system;
provide inputs based on the data set to a supervised machine learning model configured to determine significant parameters in an input data set with respect to a target variable;
receive, from the supervised machine learning model in response to the inputs, an indication of two or more significant parameters from the plurality of parameters with respect to the target variable;
generate a multivariate cluster for the target variable based on a subset of the parameter values that corresponds to the two or more significant parameters, the multivariate cluster for the target variable excluding parameter values in the subset of the parameter values that are temporally associated with a certain value range for the target variable; and
determine an anomalous state of the system with respect to the target variable based on the multivariate cluster for the target variable and data captured after the time period.

16. The system of claim 15, wherein the instructions, when executed by the one or more processors, further cause the system to determine a central vector of the multivariate cluster for the target variable, wherein the determining of the anomalous state of the system with respect to the target variable is based on comparing the data captured after the time period to the central vector.

17. The system of claim 16, wherein the determining of the anomalous state of the system with respect to the target variable is based on determining a Mahalanobis distance for the data captured after the time period based on the central vector and a covariance matrix determined from the multivariate cluster for the target variable.

18. The system of claim 15, wherein the data set includes a time series of values for the target variable associated with a corresponding time series for each of the plurality of parameters.

19. The system of claim 15, wherein the instructions, when executed by the one or more processors, further cause the system to generate a different multivariate cluster for a different target variable based on a different subset of the parameter values that corresponds to a different two or more significant parameters for the different target variable, wherein respective values in the different subset of the parameter values that are temporally associated with a particular value range for the different target variable are excluded from the different multivariate cluster for the different target variable.

20. A non-transitory computer-readable medium comprising instructions that, when executed by one or more processors of a computing system, cause the computing system to:
receive a data set comprising parameter values for a plurality of parameters captured during a time period by a plurality of sensor devices associated with a system;
provide inputs based on the data set to a supervised machine learning model configured to determine significant parameters in an input data set with respect to a target variable;
receive, from the supervised machine learning model in response to the inputs, an indication of two or more significant parameters from the plurality of parameters with respect to the target variable;
generate a multivariate cluster for the target variable based on a subset of the parameter values that corresponds to the two or more significant parameters, the multivariate cluster for the target variable excluding parameter values in the subset of the parameter values that are temporally associated with a certain value range for the target variable; and
determine an anomalous state of the system with respect to the target variable based on the multivariate cluster for the target variable and data captured after the time period.
